(19) United States
(12) Patent Application Publication
(10) Pub. No.: US 2025/0118736 A1
(43) Pub. Date: Apr. 10, 2025

(54) NEGATIVE ACTIVE MATERIAL FOR SECONDARY BATTERY, NEGATIVE ELECTRODE FOR SECONDARY BATTERY

(71) Applicant: SK On Co., Ltd., Seoul (KR)

(72) Inventors: Hyeon A KIM, Daejeon (KR); Gi Hyeon MOON, Daejeon (KR); Jong Hyuk LEE, Daejeon (KR)

(21) Appl. No.: 18/911,265

(22) Filed: Oct. 10, 2024

(30) Foreign Application Priority Data
Oct. 10, 2023 (KR) 10-2023-0134187

(51) Int. Cl. H01M 4/36; H01M 4/02; H01M 4/38; H01M 4/58; H01M 4/62

(52) U.S. Cl. CPC H01M 4/366; H01M 4/386; H01M 4/5825; H01M 2004/027; H01M 4/623

(57) ABSTRACT

The present disclosure relates to a negative active material for secondary batteries including a negative active material core, and a coating layer including an aluminum-containing compound and formed on the negative active material core, and the present disclosure relates to a negative electrode for secondary batteries comprising a negative electrode current collector; and a negative active material layer including a negative active material and a binder and formed on at least one surface of the negative electrode current collector, wherein the negative active material includes a negative active material core and a coating layer formed on the negative active material core and including an aluminum-containing compound.

### CROSS-REFERENCE TO RELATED PATENT APPLICATION

The present application claims priority under 35 U.S.C. § 119 (a) to Korean patent application number 10-2023-0134187 filed on Oct. 10, 2023, in the Korean Intellectual Property Office, the entire disclosure of which is incorporated by reference herein.

### BACKGROUND OF THE INVENTION

### 1. Field

Embodiments of the present disclosure relate to a negative active material for secondary batteries, a negative electrode for secondary batteries, and a manufacturing method of the negative electrode for secondary batteries.

### 2. Description of the Related Art

As the electronics, communications, and space industries develop, demand for lithium secondary batteries as an energy power source is drastically increasing. In particular, as the importance of global eco-friendly policies is emphasized, the electric vehicle market is growing swiftly, and research and development on lithium secondary batteries are being actively conducted worldwide.

A lithium secondary battery includes a positive electrode, a negative electrode, and a separator disposed therebetween, and a positive electrode and a negative electrode are each provided with an active material which lithium ions may be inserted to and extracted from.

A negative electrode of a lithium secondary battery contains a binder. As the binder migrates during the drying process of the negative electrode, a concentration gradient of the binder may be formed within the negative electrode. This may cause problems such as increased resistance of the negative electrode or decreased adhesion of the negative electrode, so a method to control the distribution of the binder is required.

### SUMMARY OF THE INVENTION

Embodiments of the present disclosure can provide a negative active material for secondary batteries, a negative electrode for secondary batteries, and a manufacturing method of the negative electrode for secondary batteries that can control the distribution of a binder in the negative electrode.

A secondary battery including a negative electrode for secondary batteries according to one embodiment of the present disclosure can be widely applied in the fields of electric vehicles, battery charging stations, and other green technologies, such solar power generation and wind power generation using batteries.

Meanwhile, the present disclosure can be widely applied in the fields of electric vehicles, battery charging stations, energy storage system (ESS), and other green technologies, such solar power generation and wind power generation using batteries. In addition, the present disclosure can be used in eco-friendly mobility such as electric vehicles and hybrid vehicles to prevent climate change by suppressing air pollution and greenhouse gas emissions.

A negative active material for secondary batteries according to an embodiment of the present disclosure includes: a negative active material core; and a coating layer including an aluminum-containing compound and formed on the negative active material core.

In one embodiment, the aluminum-containing compound may include one or more selected from the group consisting of Al(NO₃)₃, Al(OH)₃, AlPO₄, AlF₃, Al₂(SO₄)₃, AlCl₃, and AlI₃.

In one embodiment, the negative active material core may include a carbon-based material.

In one embodiment, the carbon-based material may include one or more selected from the group consisting of artificial graphite, natural graphite, hard carbon, soft carbon, carbon black, and graphene.

In one embodiment, the negative active material core may include a silicon-based material.

In one embodiment, the silicon-based material may include one or more selected from the group consisting of SiOₓ(0≤x<2), Si/C composite, and Si alloy.

In one embodiment, the negative active material may include the aluminum-containing compound in an amount of 0.05% by weight to 5.0% by weight.

A negative electrode for secondary batteries according to an embodiment of the present disclosure includes: a negative electrode current collector; and a negative active material layer including a negative active material and a binder and formed on at least one surface of the negative electrode current collector, wherein the negative active material includes a negative active material core and a coating layer including an aluminum-containing compound and formed on the negative active material core.

In one embodiment, the binding force between the aluminum-containing compound and the binder may be greater than the binding force between the binder and a solvent in which the negative active material and the binder may be dissolved, and the solvent may include one or more substances selected from the group consisting of water, methanol, ethanol, ethylene glycol, diethylene glycol, and glycerol.

In one embodiment, in the negative active material layer, an absolute value of an average slope of the content of the binder according to the distance from the negative electrode current collector may be 0.005% by weight/μm or less.

In one embodiment, the binder may include one or more selected from the group consisting of lithium polyacrylate (LiPAA), styrene-butadiene rubber (SBR), carboxymethylcellulose (CMC), polyacrylic acid (PAA), polyethylene oxide (PEO), polyvinylidene fluoride (PVDF), and polyvinyl alcohol (PVA).

A manufacturing method a negative electrode for secondary batteries according to an embodiment of the present disclosure includes: preparing a negative active material in which a negative active material core is coated with a coating material; and applying a negative active material composition containing the negative active material, a binder, and a solvent on at least one surface of a negative electrode current collector, wherein the binding force between the coating material and the binder is greater than the binding force between the binder and the solvent.

In one embodiment, the preparing the negative active material may include preparing a composition for preparing a negative active material by mixing the negative active material core and the coating material in the solvent.

In one embodiment, the composition for preparing a negative active material may include solids in an amount of 30% by weight to 90% by weight.

In one embodiment, the coating material may include an aluminum-containing compound.

In one embodiment, the aluminum-containing compound may include one or more selected from the group consisting of Al(NO₃)₃, Al(OH)₃, AIPO₄, AlF₃, Al₂(SO₄)₃, AlCl₃, and AlI₃.

In one embodiment, the solvent may include one or more substances selected from the group consisting of water, methanol, ethanol, ethylene glycol, diethylene glycol, and glycerol.

According to the present disclosure, a negative active material for secondary batteries, a negative electrode for secondary batteries, and a manufacturing method of the negative electrode for secondary batteries that can control the distribution of a binder in the negative electrode may be provided.

Meanwhile, the present disclosure can be widely applied in the fields of electric vehicles, battery charging stations, energy storage system (ESS), and other green technologies, such solar power generation and wind power generation using batteries. In addition, the present disclosure can be used in eco-friendly mobility such as electric vehicles and hybrid vehicles to prevent climate change by suppressing air pollution and greenhouse gas emissions.

### BRIEF DESCRIPTION OF THE DRAWINGS

FIG. 1 shows a diagram for explaining a negative active material for secondary batteries according to an embodiment of the present disclosure.

FIG. 2 shows a diagram for explaining a negative electrode for secondary batteries according to an embodiment of the present disclosure.

FIG. 3 shows a flowchart for explaining a manufacturing method of a negative electrode for secondary batteries according to an embodiment of the present disclosure.

FIG. 4 shows an image and graph illustrating the distribution of a binder in a negative electrode for secondary batteries according to one embodiment of the present disclosure.

FIG. 5 shows a diagram for explaining a negative electrode for secondary batteries according to one comparative example of the present disclosure.

FIG. 6 shows an image and graph illustrating the distribution of a binder in negative for secondary batteries according to one comparative example of the present disclosure.

FIG. 7 shows a charge/discharge graph of secondary battery cells including negative electrodes for secondary batteries according to one example and one comparative example of the present disclosure.

### DETAILED DESCRIPTION

Hereinafter, the present disclosure will be described in detail with reference to the attached drawings. However, this is merely illustrative, and the present disclosure is not limited to the specific embodiments described in an illustrative manner.

### Negative Active Material for Secondary Batteries

In one aspect of the present disclosure, provided is a negative active material for secondary batteries, including: a negative active material core; and a coating layer including an aluminum-containing compound and formed on the negative active material core.

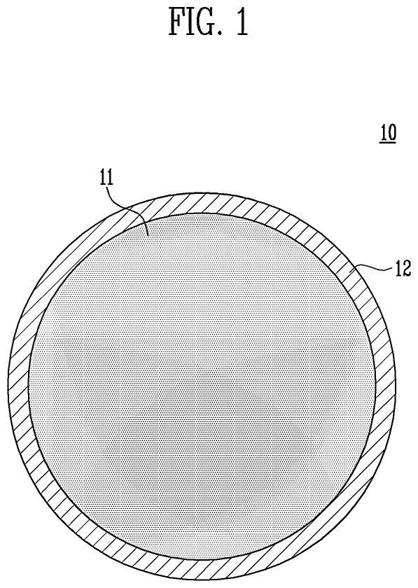

FIG. 1 shows a diagram for explaining a negative active material for secondary batteries according to an embodiment of the present disclosure. Hereinafter, a negative active material for secondary batteries according to an embodiment of the present disclosure will be described with reference to FIG. 1.

Referring to FIG. 1, a negative active material 10 for secondary batteries includes a negative active material core 11 and a coating layer 12.

A negative active material core 11 may be a material which lithium ions may be inserted to and extracted from.

In one embodiment, the negative active material core 11 may include a carbon-based material.

In one embodiment, the negative active material core 11 may include a silicon-based material.

In one embodiment, the negative active material core 11 may include a carbon-based material or a silicon-based material or both a carbon-based material and a silicon-based material.

In one embodiment, the carbon-based material may include one or more selected from the group consisting of artificial graphite, natural graphite, hard carbon, soft carbon, carbon black, and graphene. In one embodiment, the carbon black may include one or more selected from the group consisting of acetylene black, Ketjen Black, and Super P.

In one embodiment, the silicon-based material may include one or more selected from the group consisting of SiOₓ(0≤x<2), Si/C composite, and Si alloy.

A coating layer 12 may be formed on a negative active material core 11. In an embodiment, a coating layer 12 may be formed on a negative active material core 11, so that a negative active material 10 may form a core-shell structure.

A coating layer 12 may include a coating material. A coating material may be selected in consideration of the binding force with a binder used in manufacturing a negative electrode. In an embodiment, a coating material may be selected such that the binding force between a coating material and a binder is greater than the binding force between the binder and a solvent used in manufacturing a negative electrode. In an embodiment, a coating material may include an aluminum-containing compound, and in an embodiment, the aluminum-containing compound may include one or more selected from the group consisting of Al(NO₃)₃, Al(OH)₃, AlPO₄, AlF₃, Al₂ (SO₄)₃, AlCl₃, and AlI₃.

In one embodiment, the negative active material 10 may include the aluminum-containing compound in an amount of 0.05% by weight to 5.0% by weight.

When the content of a coating material is within the above-described range, a negative active material core 11 may be sufficiently coated with the coating material to suppress the migration of a binder and prevent the resistance of a negative active material layer from increasing excessively.

### Negative Electrode for Secondary Batteries

In another aspect of the present disclosure, provided is a negative electrode for secondary batteries, including: a negative electrode current collector; and a negative active material layer including a negative active material and a binder and formed on at least one surface of the negative electrode current collector, wherein the negative active material includes a negative active material core and a coating layer formed on the negative active material core and including an aluminum-containing compound.

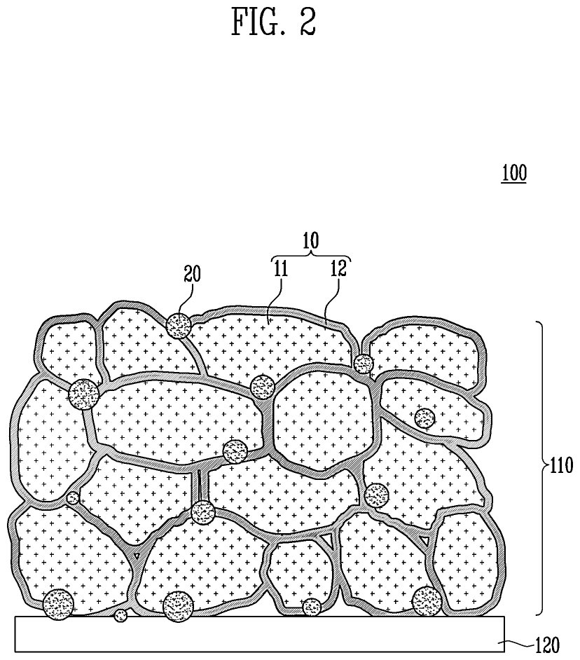

FIG. 2 shows a diagram for explaining a negative electrode for secondary batteries according to an embodiment of the present disclosure. Hereinafter, a negative electrode for secondary batteries according to an embodiment of the present disclosure will be described with reference to FIG. 2.

Referring to FIG. 2, a negative electrode 100 for a secondary batteries includes a negative electrode current collector 120 and a negative active material layer 110.

A negative current collector 120 is not particularly limited as long as it has conductivity without causing a chemical change in a secondary battery. For example, copper, stainless steel, aluminum, nickel, titanium, calcined carbon, copper or stainless steel surface-treated with carbon, nickel, titanium, silver, or the like, an aluminum-cadmium alloy, or the like may be used. In addition, fine irregularities may be formed on the surface to strengthen the binding power of a negative active material, and it may be used in various forms such as films, sheets, foils, nets, porous materials, foams, and non-woven fabrics.

A negative active material layer 110 may be formed on at least one surface of a negative electrode current collector 120. In other words, a negative active material layer 110 may be formed on one surface of a negative electrode current collector 120 or on both surfaces of the negative electrode current collector 120.

A negative active material layer 110 may include a negative active material 10 and a binder 20.

The above-described negative active material 10 may be applied as a negative active material 10. In other words, a negative active material 10 may include a negative active material core 11 and a coating layer 12 formed on a negative active material core 11 and including a coating material. In an embodiment, a coating material may include an aluminum-containing compound, and the aluminum-containing compound may include, for example, one or more selected from the group consisting of Al(NO₃)₃, Al(OH)₃, AlPO₄, AlF₃, Al₂(SO₄)₃, AlCl₃, and AlI₃.

A binder 20 may be a material that improves adhesion between a negative electrode current collector 120 and a negative active material 10. In an embodiment, a binder 20 may be a water-based binder. In an embodiment, the binder may include one or more selected from the group consisting of lithium polyacrylate (LiPAA), styrene-butadiene rubber (SBR), carboxymethylcellulose (CMC), polyacrylic acid (PAA), polyethylene oxide (PEO), polyvinylidene fluoride (PVDF), and polyvinyl alcohol (PVA).

In an embodiment, the bonding force between an aluminum-containing compound 12 and a binder 20 included in a coating layer may be greater than the bonding force between the binder 20 and a solvent used in manufacturing a negative electrode. The solvent may be a material in which the negative active material 10 and the binder 20 may be dissolved, and in an embodiment, it may be an aqueous solvent. The aqueous solvent may include, for example, one or more substances selected from the group consisting of water, methanol, ethanol, ethylene glycol, diethylene glycol, and glycerol.

In one embodiment, the content of a binder in a negative active material layer 110 may be 10.0% by weight or less based on the total content of solids of the negative active material layer 110, and in another embodiment, it may be 5.0% by weight or less. In addition, the content of a binder in a negative active material layer 110 may be 0.05% by weight or more based on the total content of solids the negative active material layer 110, and in another embodiment, it may be 0.1% by weight or more. When the binder content satisfies the above-described range, a secondary battery cell can maintain excellent adhesion between a negative active material layer 110 and a negative electrode current collector 120 while maintaining sufficient charge and discharge performance.

According to an embodiment, in the negative active material layer 110, an absolute value of an average slope of the content of a binder 20 according to the distance from the negative electrode current collector 120 may be 0.005% by weight/μm or less. In other words, in one embodiment, an average slope of the content of a binder 20 according to the distance from a negative electrode current collector 120 may be −0.005 by weight/μm to 0.005 by weight/μm, and in another embodiment, it may be 0 to 0.005 by weight/μm. The average slope value of the content of a binder 20 may be a value for the entire thickness of a negative active material layer 110. In other words, the average slope value of the content of a binder 20 according to the distance from a negative electrode current collector 120 may be the average slope value of the content of the binder 20 from a surface of the negative electrode current collector 120 to a surface of the negative active material layer 110.

Migration of a binder 20 toward a surface of a negative electrode 100 within a negative active material layer 110 due to evaporation of a solvent may be suppressed by the binding of a coating material and the binder 20. As a result, due to the presence of a sufficient amount of binder 20 at an interface between the negative active material layer 110 and the negative electrode current collector 120, the adhesion between the negative active material layer 110 and the negative electrode current collector 120 can be improved.

In addition, to improve the adhesion between a negative active material layer 110 and a negative electrode current collector 120, a separate binder layer disposed between the negative active material layer 110 and the negative electrode current collector 120 may not be provided. A binder layer may be an area where the content of a binder 20 is relatively higher than that of a negative active material layer 110, and a binder layer may serve as a resistor between a negative active material layer 110 and the negative electrode current collector 120 to maintain the resistance within a secondary battery cell.

In addition, even when a negative active material layer 110 includes a relatively small amount of binder 20 compared to a conventional one, sufficient adhesion between a negative active material layer 110 and a negative electrode current collector 120 may be ensured. Therefore, the energy density within a secondary battery cell can be improved.

Furthermore, as the migration of a binder 20 toward a surface of a negative electrode 100 in a negative active material layer 110 is suppressed, the binder 20 may not be present in an excessive amount on the surface of the negative electrode 100, thereby improving the problem of excessively increasing the resistance of the negative electrode 100.

In an embodiment, a negative active material layer 110 may further include a conductive material capable of providing conductivity to a negative electrode 100. A conductive material may include, for example, one or more selected from the group consisting of metal-based conductive materials, carbon-based conductive materials, and conductive polymers. A metal-based conductive material may be, for example, metal powder or metal fibers of copper, nickel, aluminum, silver, or the like; a conductive whisker such as zinc oxide and potassium titanate; or a conductive metal oxide such as titanium oxide. A carbon-based conductive material may be, for example, graphite, carbon black, graphene, or carbon nanotubes. A conductive polymer may be, for example, a polyphenylene derivative.

In an embodiment, a negative active material layer 110 may selectively further include a thickener to obtain advantages in the manufacturing process. A thickener may improve the problem of cracks generated on the surface of a negative electrode by strengthening the cohesion of a binder. A thickener may include, for example, one or more selected from the group consisting of carboxymethyl cellulose, methyl cellulose, hydroxypropyl cellulose, methyl hydroxypropyl cellulose, ethyl hydroxyethyl cellulose, methyl ethyl hydroxyethyl cellulose, and cellulose gum.

### Manufacturing Method of Negative Electrode for Secondary Batteries

In another aspect of the present disclosure, provided is a manufacturing method a negative electrode for secondary batteries according to an embodiment of the present disclosure, including: preparing a negative active material in which a negative active material core is coated with a coating material; and applying a negative active material composition containing the negative active material, a binder, and a solvent on at least one surface of a negative electrode current collector, wherein the binding force between the coating material and the binder is greater than the binding force between the binder and the solvent.

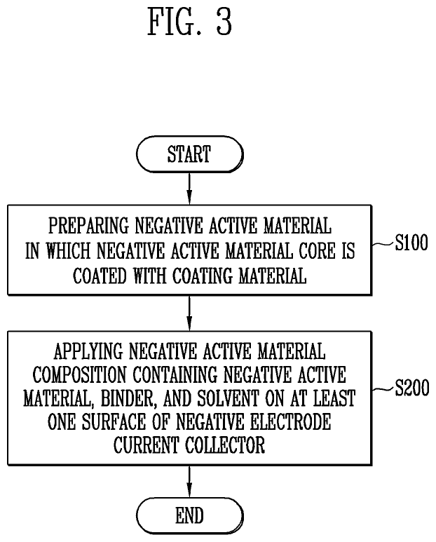

FIG. 3 shows a flowchart for explaining a manufacturing method of a negative electrode for secondary batteries according to an embodiment of the present disclosure. Hereinafter, a manufacturing method a negative electrode for secondary batteries according to an embodiment of the present disclosure will be described with reference to FIG. 3.

Referring to FIG. 3, in step S100, a negative active material in which a negative active material core is coated with a coating material may be prepared.

In an embodiment, step S100 may include preparing a composition for preparing a negative active material by mixing a negative active material core and a coating material in a first solvent. In an embodiment, a first solvent may be a material in which a negative active material core and a coating material may be dissolved, for example, a first solvent may include one or more substances selected from the group consisting of water, methanol, ethanol, ethylene glycol, diethylene glycol, and glycerol.

A composition for preparing a negative active material may include solids in an amount of 30% by weight to 98% by weight, and more specifically, it may include solids in an amount of 50% by weight to 95% by weight. The solids may include a negative active material core and a coating material.

When the content of solids is less than 30% by weight, the content of a negative active material may be too small, which may cause the problem that the manufactured negative electrode may not function properly, and when the content of solids exceeds 98% by weight, there may be the problem that a negative active material is difficult to be uniformly coated.

In addition, step S100 may further include drying the composition for preparing a negative active material. By drying the negative active material composition, a negative active material in which a negative active material core is coated with a coating material may be formed. This negative active material may be the same as the negative active material described in FIGS. 1 and 2.

Next, in step S200, a negative active material composition including a negative active material, a binder, and a second solvent may be applied on at least one surface of a negative electrode current collector.

The negative active material may be a negative active material prepared in step S100.

In an embodiment, a binder may be a material that improves adhesion between a negative electrode current collector and a negative active material, and for example, a binder may include one or more selected from the group consisting of LiPAA, SBR, CMC, PAA, PEO, PVDF, and PVA.

In an embodiment, a second solvent may be a material in which a negative active material and a binder may be dissolved, for example, a second solvent may include one or more substances selected from the group consisting of water, methanol, ethanol, ethylene glycol, diethylene glycol, and glycerol.

In an embodiment, the binding force between a coating material and a binder may be greater than the binding force between the binder and a second solvent.

In an embodiment, a coating material may include an aluminum-containing compound, and the aluminum-containing compound may include, for example, one or more selected from the group consisting of Al(NO₃)₃, Al(OH)₃, AlPO₄, AlF₃, Al₂ (SO₄)₃, AlCl₃, and AlI₃.

After step S200, a step of drying the negative active material composition applied on at least one surface of the negative electrode current collector may be further included.

As a negative active material composition is dried, a second solvent included in the negative active material composition may evaporate. However, despite the evaporation of the second solvent, migration of a binder may be suppressed.

Accordingly, before the applying the negative active material composition, applying a binder composition on a negative electrode current collector, which was conventionally performed, may not be necessary. A binder composition is a composition in which the content of binder is relatively higher than that of the negative active material composition, and it may be applied on a negative electrode current collector before applying a negative active material composition to improve the adhesion between a negative electrode current collector and a negative active material.

In addition, even though a negative active material composition contains a relatively small amount of binder compared to the conventional one, sufficient adhesion between a negative active material and a negative electrode current collector can be ensured.

### Secondary Battery

In addition, in another aspect of the present disclosure, a secondary battery including the above-described negative electrode for secondary batteries may be provided.

As described above, a negative electrode for secondary batteries may include a negative electrode current collector and a negative active material layer. A negative active material layer may include a negative active material and a binder and may be formed on at least one surface of a negative electrode current collector. A negative active material may include a negative active material core and a coating layer formed on the negative active material core and including an aluminum-containing compound.

A secondary battery includes a positive electrode and a separator in addition to a negative electrode according to the present disclosure. A positive electrode may include a positive electrode current collector and an active material layer disposed on the positive electrode current collector. An active material layer may include an active material. For example, a positive active material layer may include a positive active material, and a positive active material may be a material which lithium ions may be inserted to and extracted from.

A positive active material may be a lithium metal oxide. For example, a positive active material may be one of a lithium manganese-based oxide, a lithium nickel-based oxide, a lithium cobalt-based oxide, a lithium nickel manganese-based oxide, a lithium nickel cobalt aluminum-based oxide, a lithium iron phosphate-based compound, a lithium manganese phosphate-based compound, and a lithium cobalt phosphate-based compound, and a lithium vanadium phosphate-based compound, and is not necessarily limited to a specific example.

A separator may be interposed between a negative electrode and a positive electrode. A separator is formed to prevent electrical short-circuiting between a negative electrode and a positive electrode and to generate a flow of ions. A separator may include a porous polymer film or a porous non-woven fabric. Here, the porous polymer film may be formed to be a single layer or a multilayer including a polyolefin-based polymer such as an ethylene polymer, a propylene polymer, an ethylene/butene copolymer, an ethylene/hexene copolymer, and an ethylene/methacrylate copolymer. The porous nonwoven fabric may include glass fibers with a high melting point and polyethylene terephthalate fibers. However, it is not limited thereto, and depending on the embodiment, a separator may be a highly heat-resistant separator (ceramic coated separator; CCS) including ceramic.

A negative electrode, a positive electrode, and a separator may be manufactured into an electrode assembly by winding, lamination, folding, or zigzag stacking processes. In addition, an electrode assembly may be provided together with an electrolyte solution to manufacture a secondary battery according to the present disclosure. A secondary battery may be any one of a cylindrical type using a can, a prismatic type, a pouch type, or a coin type, but is not limited thereto.

An electrolyte solution may be a non-aqueous electrolyte solution. An electrolyte solution may include a lithium salt and an organic solvent. The organic solvent may include at least any one of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, or tetrahydrofuran.

### EXAMPLES

Hereinafter, embodiments of the present invention will be further described with reference to specific experimental examples. The examples and comparative examples included in the experimental examples are merely illustrative of the present invention and do not limit the scope of the appended claims, and it is obvious to those skilled in the art that various modifications and changes to the examples are possible within the scope and technical idea of the present invention, and it is also obvious that such modifications and changes fall within the scope of the appended claims.

### <Preparation Example 1>—Preparation of Negative Active Material

A negative active material core prepared by mixing artificial graphite and natural graphite mixed at a weight ratio of 7:3 was added to an aqueous solution in which aluminum nitrate (Al(NO₃)₃) was dissolved. The amount of the negative active material core was adjusted so that the content of solids contained in the aqueous solution into which the negative active material core was added became 50% by weight to 95% by weight.

The aqueous solution to which the negative active material core was added was mixed for a certain period of time using a mixer, and then vacuum-dried to prepare a negative active material in which a coating layer including aluminum nitrate was formed on the negative active material core.

### <Example 1>—Manufacturing of Negative Electrode

A negative active material composition was prepared by mixing the negative active material of Preparation Example 1, multi-walled carbon nanotubes, carboxymethyl cellulose, and SBR in water at a ratio of 95.8:0.4:1.2:2.6 based on weight.

The prepared negative active material composition was applied to a copper thin film that is a negative electrode current collector. Thereafter, the composition was dried under vacuum at 130° C. for 1 hour to manufacture a negative electrode including the negative active material layer formed on the copper thin film.

The structure of the negative electrode of Example 1 may be understood with reference to FIG. 2.

### <Comparative Example 1>—Manufacturing of Negative Electrode

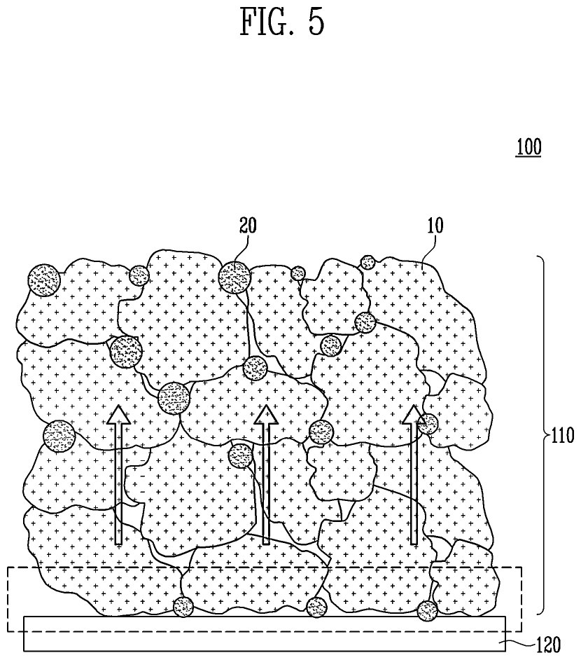

FIG. 5 shows a diagram for explaining a negative electrode for secondary batteries according to one comparative example of the present disclosure.

A negative electrode was manufactured in the same manner as in Example 1, except that instead of the negative active material of Preparation Example 1, a negative active material obtained by mixing artificial graphite and natural graphite at a weight ratio of 7:3 was used.

The negative active material used in Comparative Example 1, unlike the negative active material prepared in Preparation Example 1, does not have a coating layer on graphite.

The structure of the negative electrode of Comparative Example 1 may be understood with reference to FIG. 5.

### <Experimental Example 1>—Confirmation of Binder Distribution and Adhesion

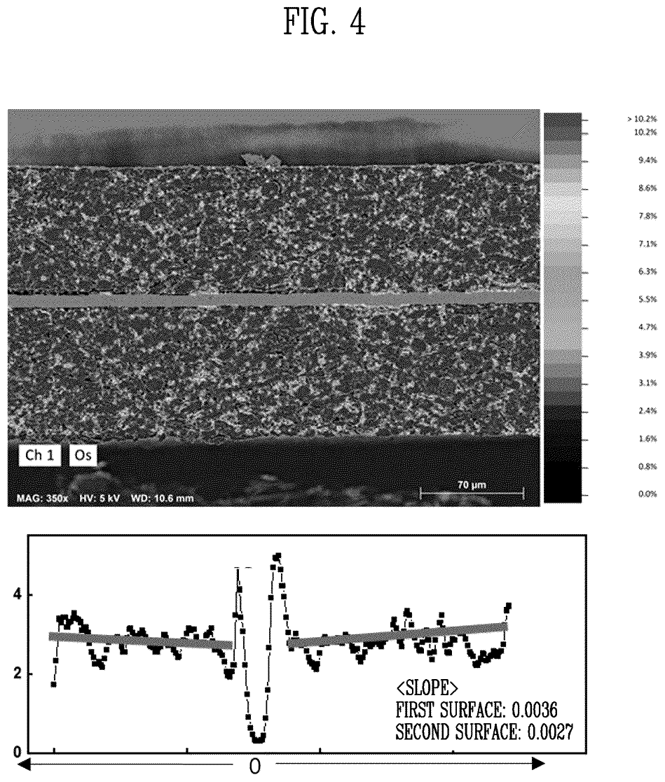

FIG. 4 shows an image and graph illustrating the distribution of a binder in a negative electrode for secondary batteries according to one embodiment of the present disclosure.

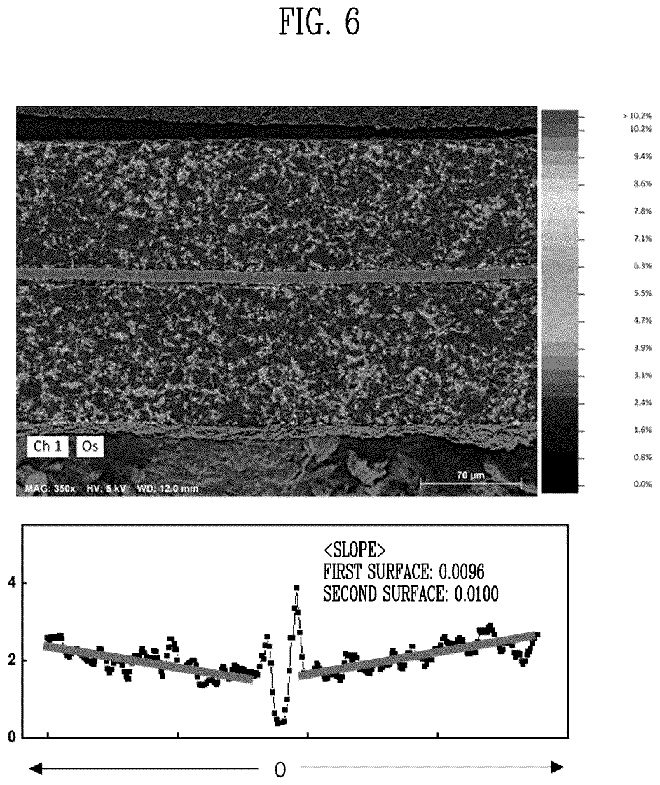

FIG. 6 shows an image and graph illustrating the distribution of a binder in negative for secondary batteries according to one comparative example of the present disclosure.

To detect a binder in a negative electrode, the negative electrodes manufactured in Example 1 and Comparative Example 1 were stained with osmium tetroxide (OsO₄). In other words, osmium tetroxide (OsO₄) was bound to the binder in the negative electrodes. Thereafter, a cross-section of the negative electrodes was cut and analyzed by energy dispersive X-ray spectroscopy. The results for Example 1 are shown in FIG. 4, and the results for Comparative Example 1 are shown in FIG. 6. In the analytical results obtained by energy dispersive X-ray spectroscopy, the distribution of osmium (Os) element on the cross-section of the negative electrodes represents the distribution of the binder SBR.

In addition, based on the analytical results obtained by energy dispersive X-ray spectroscopy, graphs showing the binder content according to the distance from a negative electrode current collector are shown in FIGS. 4 and 6, and the absolute value of the slope in each graph is shown in Table 1 below.

TABLE 1

| | Slope of | Slope of |
|---|---|---|
| | first surface | second surface |
| | (% by weight/μm) | (% by weight/μm) |
| Example 1 | 0.0036 | 0.0027 |
| Comparative Example 1 | 0.0096 | 0.0100 |

In Table 1, the first surface and the second surface each refer to both surfaces of a negative electrode current collector on which a negative active material layer is formed.

Referring to FIGS. 4 and 6 and Table 1, in the case of Comparative Example 1 where a negative active material in which a coating layer was not formed was used, it can be confirmed that the binder content according to the distance from a negative electrode current collector exceeds 0.005% by weight/μm. In FIGS. 4 and 6, the relatively high binder content near the negative electrode current collector is assumed to be an error caused by the osmium tetroxide (OsO₄) that was added simply to confirm the binder content.

In other words, in the case of a negative active material in which a coating layer was not formed, it can be confirmed that the binder migrated to the negative electrode surface during the drying after applying the negative active material composition (see FIG. 5).

On the other hand, in Example 1 where a negative active material of Preparation Example 1 was used, the binder content according to the distance from a negative electrode current collector was 0.005% by weight/μm or less, confirming that the binder was relatively uniformly distributed throughout the negative active material layer. In other words, it can be confirmed that when the negative active material of Preparation Example 1 was used, migration of the binder was suppressed.

### <Experimental Example 2>—Evaluation of Adhesion

The negative electrodes manufactured in Example 1 and Comparative Example 1 were punched out to a size of 20 mm×150 mm and fixed to the center of a 25 mm×75 mm slide glass using double-sided tape, and then a universal testing machine (UT; manufacturer: LLOYD Instrument LTD., device name: LF Plus) was used to peel the negative active material layer from the negative electrode current collector and measure the 90-degree peeling strength (adhesion), and the results are shown in Table 2 below.

TABLE 2

| | Adhesion |
|---|---|
| | (N) |
| Example 1 | 0.64 |
| Comparative Example 1 | 0.29 |

Referring to Table 2, it can be confirmed that although both the negative electrode of Example 1 and the negative electrode of Comparative Example 1 contained the same amount of binder, the adhesion between the negative electrode current collector and the negative active material layer was significantly better in the negative electrode of Example 1 where the negative active material of Preparation Example 1 was used.

### <Experimental Example 3>—Confirmation of Charge/Discharge Performance

### Manufacturing of a Coin Half-Cell

CR2032 type coin half cells were manufactured using each of the negative electrode of Example 1 and the negative electrode of Comparative Example 1. Metal lithium was used as a counter electrode, PE separator was used as a separator, and 1.0 M LiPF₆ dissolved in a mixed solvent of ethylene carbonate (EC), diethyl carbonate (DEC), and dimethyl carbonate (DMC) (3:5:2 volume ratio) was used as an electrolyte.

### Confirmation of Charge/Discharge Performance

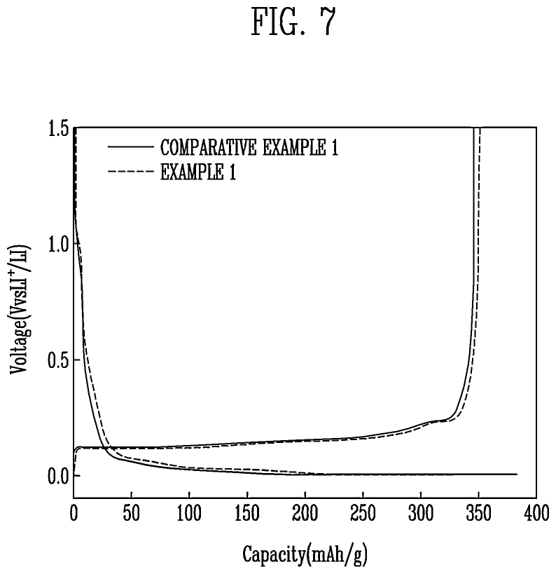

FIG. 7 shows a charge/discharge graph of secondary battery cells including negative electrodes for secondary batteries according to one example and one comparative example of the present disclosure.

FIG. 7 shows the charge capacity measured when the manufactured coin half-cells were charged to 1.5 V (vs. Li/Li⁺) at 0.1 C and the discharge capacity measured when the manufactured coin half-cells were discharged to 0.05 V (vs. Li/Li⁺) at 0.1 C each at 25° C., and the reversible capacity was calculated based on the charge capacity and discharge capacity as shown in Table 3 below.

TABLE 3

| | Reversible capacity |
|---|---|
| | (mAh/g) |
| Example 1 | 348.87 |
| Comparative Example 1 | 343.81 |

Referring to FIG. 7 and Table 3, the reversible capacity of Example 1 was 348.87 mAh/g, confirming that the charge/discharge performance was superior to Comparative Example 1, which exhibited reversible capacity of 343.81 mAh/g.

Example 1 has relatively good adhesion between the negative electrode current collector and the negative active material layer, so it can prevent detachment and peeling of the negative active material from occurring, whereas in the case of Comparative Example 1, detachment and peeling of the negative active material may occur. This difference may cause differences in the charge/discharge performance.

In addition, in Example 1, the binder is uniformly distributed throughout the entire negative electrode, whereas in Comparative Example 1, the binder may be excessively concentrated on the negative electrode surface, and so the resistance of the negative electrode surface may be relatively increased in Comparative Example 1. This difference may also cause differences in the charge/discharge performance.

What is claimed is:

1. A negative active material for secondary batteries, comprising:
a negative active material core; and
a coating layer including an aluminum-containing compound and formed on the negative active material core.

2. The negative active material for secondary batteries according to claim 1, wherein the aluminum-containing compound includes one or more selected from the group consisting of Al(NO₃)₃, Al(OH)₃, AlPO₄, AlF₃, Al₂ (SO₄)₃, AlCl₃, and AlI₃.

3. The negative active material for secondary batteries according to claim 1, wherein the negative active material core includes a carbon-based material.

4. The negative active material for secondary batteries according to claim 3, wherein the carbon-based material includes one or more selected from the group consisting of artificial graphite, natural graphite, hard carbon, soft carbon, carbon black, and graphene.

5. The negative active material for secondary batteries according to claim 1, wherein the negative active material core includes a silicon-based material.

6. The negative active material for secondary batteries according to claim 5, wherein the silicon-based material includes one or more selected from the group consisting of SiOₓ(0≤x<2), Si/C composite, and Si alloy.

7. The negative active material for secondary batteries according to claim 1, wherein the negative active material includes the aluminum-containing compound in an amount of 0.05% by weight to 5.0% by weight.

8. A negative electrode for secondary batteries, comprising:
a negative electrode current collector; and
a negative active material layer including a negative active material and a binder and formed on at least one surface of the negative electrode current collector,
wherein the negative active material includes a negative active material core and a coating layer formed on the negative active material core and including an aluminum-containing compound.

9. The negative electrode for secondary batteries according to claim 8, wherein in the negative active material layer, an absolute value of an average slope of the content of the binder according to the distance from the negative electrode current collector is 0.005% by weight/μm or less.

10. The negative electrode for secondary batteries according to claim 8, wherein the binder includes one or more selected from the group consisting of lithium polyacrylate (LiPAA), styrene-butadiene rubber (SBR), carboxymethylcellulose (CMC), polyacrylic acid (PAA), polyethylene oxide (PEO), polyvinylidene fluoride (PVDF), and polyvinyl alcohol (PVA).
